(19) United States
(12) Patent Application Publication
(10) Pub. No.: US 2010/0113025 A1
(43) Pub. Date: May 6, 2010

(54) METHOD AND APPARATUS FOR FORCING INTER-RAT HANDOVER

(75) Inventors: Paul Maxwell Martin, Hampshire (GB); Riki Benjamin Dolby, Hampshire (GB)

Correspondence Address: NIXON PEABODY, LLP, 401 9TH STREET, NW, SUITE 900, WASHINGTON, DC, 20004-2128, US

(73) Assignee: M.M.I. RESEARCH LIMITED, Wimborne, Dorset (GB)

(21) Appl. No.: 12/594,387

(22) PCT Filed: Sep. 22, 2008
(86) PCT No.: PCT/GB08/03210

§ 371 Date: Oct. 2, 2009

(30) Foreign Application Priority Data
Oct. 8, 2007 (GB) 0719639.7

(51) Int. Cl. H04W 36/00

(52) U.S. Cl. 455/436

(57) ABSTRACT

The present invention relates to a method and apparatus for forcing a mobile device to handover from a first cellular network radio access technology (RAT) to a second radio access technology (RAT) different from the first cellular network radio access technology. The method comprises: establishing a connection with the mobile device using the first cellular network radio access technology; sending a handover command to the device using the first cellular network radio access technology, the handover command including details of radio resources of the second cellular network radio access technology; and establishing a connection with the mobile device using the radio resources of the second cellular network radio access technology which were specified in the handover command. These steps are each performed by a separately introduced base station which is not under the control of a cellular network.

### FIELD OF THE INVENTION

The present invention relates to a method and apparatus for forcing a mobile device to handover from a first cellular network radio access technology (RAT) to a second radio access technology (RAT) different from the first cellular network radio access technology.

### BACKGROUND OF THE INVENTION

WO 2007/010220 describes various methods of setting up a call with a mobile device using a separately introduced base station which is not under the control of a cellular network. Once the call has been set up, a direction finder is used to determine the direction of the device. The call can be set up using either a second generation (2G) RAT such as GSM, or a third generation (3G) RAT such as UMTS.

It can be difficult if not impossible to establish a sustained call using a 3G RAT. In addition only 2G or 3G direction finding equipment may be available. Also, direction finding using 3G techniques is more covert due to 3G signal energy being spread over a wider bandwidth.

### SUMMARY OF THE INVENTION

A first aspect of the invention provides a method of forcing a mobile device to handover from a first cellular network radio access technology to a second radio access technology different from the first cellular network radio access technology, the method comprising:
a. establishing a connection with the mobile device using the first cellular network radio access technology;
b. sending a handover command to the device using the first cellular network radio access technology, the handover command including details of radio resources of the second cellular network radio access technology; and
c. establishing a connection with the mobile device using the radio resources of the second cellular network radio access technology which were specified in the handover command,
wherein steps a., b. and c. are each performed by a separately introduced base station which is not under the control of a cellular network.

A second aspect of the invention provides apparatus for forcing a mobile device to handover from a first cellular network radio access technology to a second radio access technology different from the first cellular network radio access technology, the apparatus comprising;
a. a first separately introduced base station configured to establish a connection with the mobile device using the first cellular network radio access technology, and send a handover command to the device using the first cellular network radio access technology, the handover command causing the device to handover to the second cellular network radio access technology;
b. a second separately introduced base station configured to establish a connection with the mobile device using the second cellular network radio access technology; and
c. a communication link between the first and second separately introduced base stations,
   wherein the first and second separately introduced base stations are not under the control of a cellular network.

One alternative method of using a separately introduced base station which is not under the control of a cellular network to force a mobile device to handover from a first cellular network RAT to a second cellular network RAT might be to transmit a jamming signal. This jamming signal would cause the signal quality to deteriorate for any devices within range of the base station, and force them to switch from one RAT to another. However such jamming techniques are not generally permitted due to causing substantial disruption to the surrounding mobile networks, and cannot be used to force only a selected target device to switch. Surprisingly, it has been found that a handover command of the first cellular network (RAT) can be used to force handover. In contrast to a jamming signal, the use of such a handover command does not cause disruption to the surrounding networks and can be targeted to a specific device or devices if necessary.

Once the device has been forced to handover from the first cellular network radio access technology to the second radio access technology, then a variety of processes may be performed using the second cellular network radio access technology, including (but not limited to):
determining the direction of the device by: receiving a locator signal from the device at a direction finder; and determining the direction of the device relative to the direction finder by measuring the direction of arrival of the locator signal
voice interception

Typically the first or second first cellular network radio access technology is a frequency-division multiple-access technology such as GSM.

Typically the first or second first cellular network radio access technology is a code-division multiple-access technology such as WCDMA, CDMAOne, CDMA2000, TD-SCDMA or TD-CDMA.

Advantageously the handover command is sent to the device before the separately introduced base station is required to complete an authentication process with the device.

Typically the radio resources comprise information identifying a channel of the second cellular network radio access technology. For instance the information may identify an ARFCN and timeslot, or a UARFCN and primary scrambling code.

Typically the method further comprises selecting a target device (or devices); and configuring the separately introduced base station to force the target device(s) to handover by performing steps a. b. and c. For instance the separately introduced base station may be configured by entering into the separately introduced base station an identifier, such as an IMSI or IMEI, associated with the target device. This identifier may be acquired previously, or may be acquired by sending an identity request to the target device from the separately introduced base station, and receiving the identifier from the target device in response to the identity request. Optionally the target device may also send a location update request to the base station prior to the base station sending the identity request.

A further aspect of the invention provides a computer program product which, when run on one or more computers, causes the computer(s) to perform a method of the first aspect of the invention.

### BRIEF DESCRIPTION OF THE DRAWINGS

Embodiments of the invention will now be described with reference to the accompanying drawings, in which:

FIG. 1 is a schematic diagram showing a GSM network including a mobile station (MS) receiving multiple Broadcast Channels (BCH), and a Separately Introduced Mobile BTS (SIMBTS);

FIG. 2 shows the SIMBTS in further detail;

FIG. 3 is a schematic diagram showing a 3G network including a User Equipment device (UE), and a SINodeB;

FIG. 4 shows the SINodeB in further detail; and

FIG. 5 shows a region where GSM and 3G networks are overlaid in space.

### DETAILED DESCRIPTION OF EMBODIMENT(S)

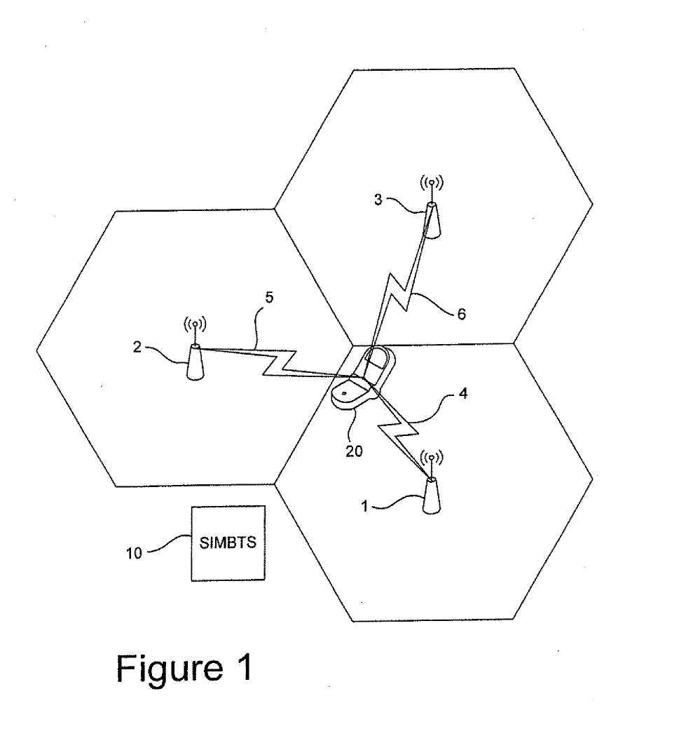

FIG. 1 shows a GSM network comprising three BTSs 1-3 broadcasting to three cells by downlink transmissions 4-6 each having a unique frequency. The BTSs 1-3 broadcast these transmissions under the control of the GSM cellular network. On moving into the vicinity of the three BTSs, a GSM Mobile Station (MS) 20 evaluates on which BTS to camp. Once communications with the network are established then the MS 20 is authenticated by the network and can move to an idle state.

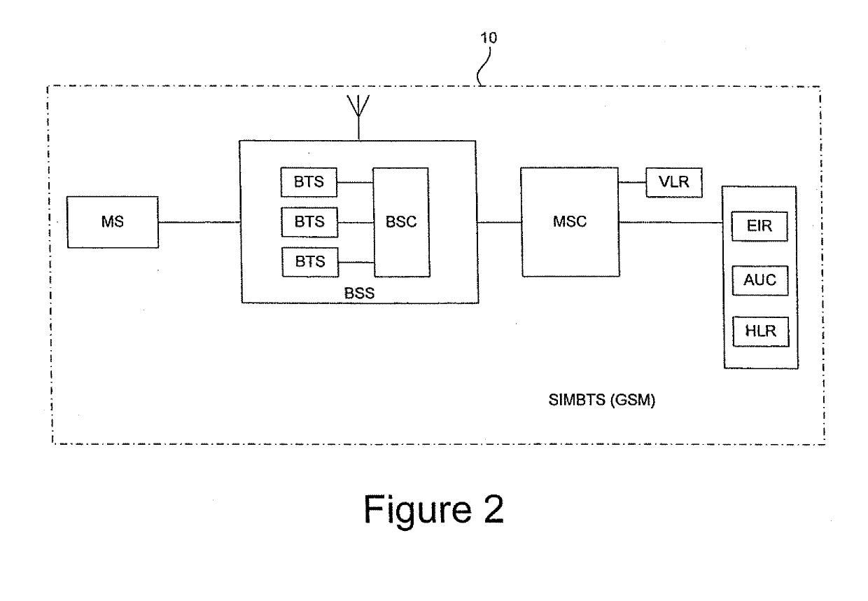

FIG. 1 also shows a separately introduced mobile BTS (SIMBTS 10) geographically located in the region of the cellular layout of the GSM network. The SIMBTS 10 is independent of the conventional GSM networks—that is, it is not under the control of the GSM network which controls the BTSs 1-3, or any other cellular network. The SIMBTS 10 typically is a mobile device operated locally. Configuring the SIMBTS 10 appropriately (as described in WO 2007/010223 and WO 2007/010220), it is possible to attract an MS from the conventional GSM network and obtain its IMSI, IMEI and TMS™ identities. FIG. 2 shows the functional elements of the SIMBTS 10 in more detail.

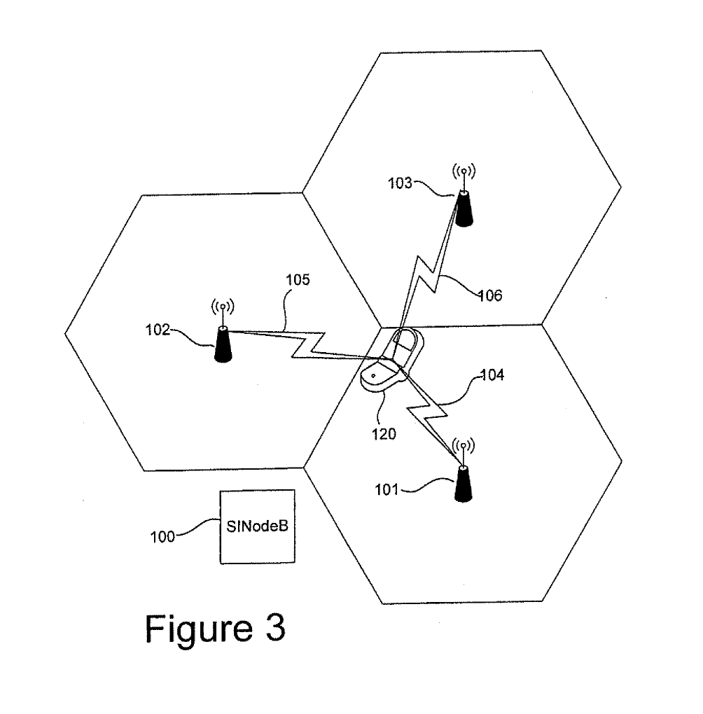

FIG. 3 shows a 3G network comprising three NodeBs 101-103 broadcasting to three cells by downlink transmissions 104-106 each having a unique downlink scrambling code. The NodeBs 101-103 broadcast these transmissions under the control of the 3G cellular network. On moving into the vicinity of the three NodeBs, a User Equipment device (UE) 120 evaluates on which NodeB to camp. Once communications with the network are established then the UE is authenticated by the network and can move to an idle state.

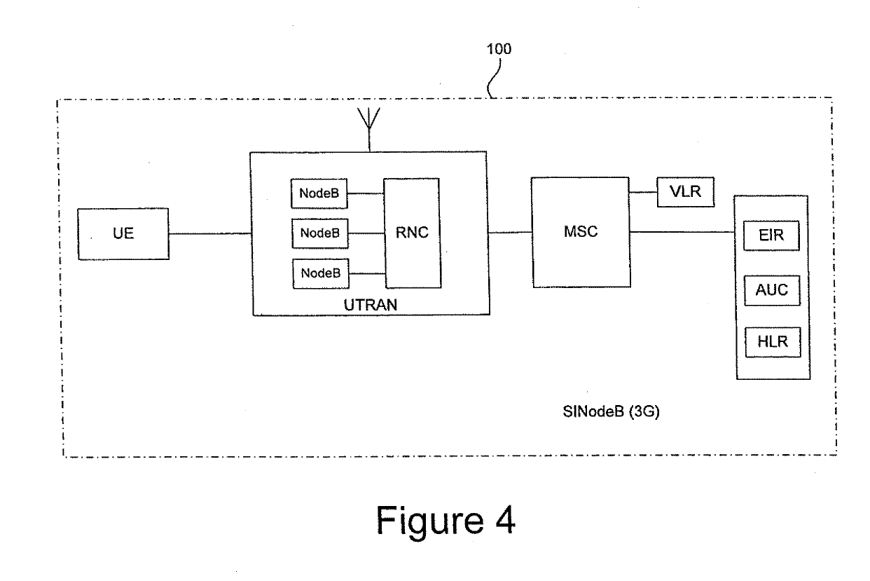

FIG. 3 also shows a separately introduced Node B (SINodeB) 100 geographically located in the region of the cellular layout of the 3G network. The SINodeB 100 is independent of the conventional 3G networks—that is, it is not under the control of the 3G network which controls the NodeBs 101-103, or any other cellular network. The SINodeB 100 typically is a mobile device operated locally. Configuring the SINodeB 100 appropriately (as described in WO 2007/010223 and WO 2007/010220), it is possible to attract a UE from the conventional 3G network and obtain its IMSI, IMEI and TMSI identities. FIG. 4 shows the functional elements of the SINodeB 100 in more detail.

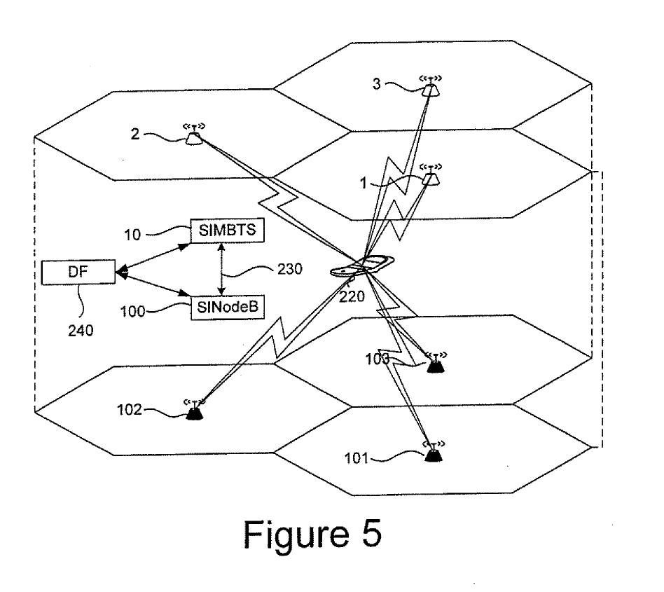

FIG. 5 shows a region where GSM and 3G networks are overlaid in space. Mobile device 220 is simultaneously evaluating both GSM and 3G networks. Device 220 is referred to below as an MS/UE 220. SIMBTS 10 and SINodeB 100 are connected by a link 230 and communicate information related specifically to a forcing function as described below. Note that the link 230 is a direct communication link between the base stations—that is, a link not including any intermediate network elements as in a conventional communication between a GSM BTS and a 3G NodeB.

Note that the SIMBTS 10 and SINodeB 100 are illustrated in FIG. 5 as physically separate and independent units which may be spaced apart by some distance. Alternatively the SIMBTS 10 and SINodeB 100 may be integrated together within a single piece of apparatus and/or may share certain resources (antennas, memory, processors etc). In this case the communication link 230 may be a physical link within the apparatus, or a virtual link implemented in software between the various functional elements shown in FIGS. 2 and 4.

For the situation where the MS/UE 220 has evaluated the conventional 3G network as preferable to the 2G network, it camps on to the 3G network. The SINodeB 100 then attracts the MS/UE 220 to it and subsequently retrieves its IMSI, IMEI and TMS™. Having acquired the IMSI and IMEI identities, it is possible to compare these with a list of target identities. If one or more of the captured identities correspond with one of the target identities then the following forcing procedure is undertaken.

The mechanism for the controlled forcing of the MS/UE 220 from the network 3G RAT to a GSM RAT controlled by the SIMBTS 10 involves the coordinated handover of the MS/UE 220 from the SINodeB to the SIMBTS 10 using a coordinated handover operation. A summary of the steps to force the MS/UE 220 to the GSM SIMBTS 10 is as follows:
1 Configure the SINodeB 100 with the IMSI and IMEI of one or more target devices, selected specifically to be subjected to the force from 3G to 2G operation. This can be manually entered in by an operator with the information having been previously discovered. Alternatively the information can be acquired from devices using a method as described in WO 2007/010223; stored in an IMSI/IMEI database which is part of the SINodeB 100 or at least available to the SINodeB, and looked up from that database to configure the SINodeB.
2 Configure the SINodeB 100 to a mode where 3G mobile devices in range, and currently camped on network Node Bs 101-103, will attempt to register to the SINodeB 100.
3 MS/UE 220 selects SINodeB 100 as a preferred Node B and starts a Location Updating procedure.
4 SINodeB 100 then receives an RRC Connection Request on the Uplink RACH channel from the MS/UE 220 SINodeB 100 sends a Radio Link (RL) Setup Request to MS/UE 220
6 MS/UE 220 sends an RL Setup Response message to SINodeB 100
7 SINodeB 100 sends an RRC Connection Setup to MS/UE 220
8 MS/UE 220 sends an RRC Connection Setup Complete to SINodeB 100. This completes the establishment of an RRC connection between the SINodeB 100 and the MS/UE 220 which moves to a CELL_DCH state
9 MS/UE 220 sends an MM Location Update Request to SINodeB 100 SINodeB 100 issues an MM Identity Request (IMSI), an MM Identity Request (IMEI) and optionally an MM Identity Request (TMSI) to MS/UE 220
11 MS/UE 220 responds by sending IMSI, IMEI and optionally TMSI Identity Response messages to the SINodeB.
12 SINodeB 100 compares the IMSI and/or the IMEI identities with a stored list of targets. If the identities match with one of the entries in the target list then the SINodeB 100 begins the forcing from 3G to GSM operation. Note that the RRC Connection between SINodeB 100 and MS/UE 220 remains active during the detection and forcing operation. Note also that the MS/UE 220 is in the CELL_DCH state.
13 SINodeB 100 issues a bespoke message to the SIMBTS 10 over link 230 requesting GSM Handover channel parameters
14 SIMBTS 10 responds to the SINodeB 100 with the Handover Channel parameters over link 230 SIMBTS 10 is configured to accept MS/UE 220 using the parameters sent to the SINodeB 100 in step 14
16 SINodeB 100 issues an RRC Handover from UTRAN Command to the MS/UE 220. This encapsulates the standard GSM Handover command as specified in GSM standard 04.18 or equivalent GERAN standard (44.18). (Note 1).
17 The MS/UE 220 receives the RRC Handover from UTRAN command and immediately moves to the GSM frequency and timeslot configured in step 15 and begins to send Handover Access messages on the GSM frequency and timeslot
18 On receipt of Handover Access messages from MS/UE 220, SIMBTS 10 sends Physical Information messages with full radio channel allocation parameters
19 MS/UE 220 sends Handover Complete to the SIMBTS 10. A full GSM traffic channel is now established between SIMBTS 10 and MS/UE 220
20 The SIMBTS 10 sends a Handover Success message to the SINodeB 100 (Note 2) over link 230
21 The SINodeB 100 then removes radio resources and contexts assigned to MS/UE 220
22 A normal blind call setup procedure is then followed as described in WO 2007/010220 to maintain the GSM link activity after the Location Update process times out

Note 1: A key point is that the RRC Handover from UTRAN command is issued prior to authentication completing. The Handover from UTRAN Command conventionally requires integrity protection, however if the handover command is sent before the security context is established, then the handover to GSM is allowed to occur.

Note 2: This message mimics the function of a GSM MSC message sent to a 3G RNC. However the bespoke implementation removes the need for these complicated and expensive network elements.

The parameters for the GSM Handover Command are provided by the SIMBTS 10 unit which the MS/UE 220 is to be handed over to. The destination ARFCN and timeslot of the Blind call is therefore precisely controlled. This then enables direction finding equipment 240 to be configured with the destination ARFCN and timeslot a priori. Using this technique enables a highly efficient speed of transfer from 3G to 2G.

On receipt of the destination ARFCN and timeslot information from the SIMBTS 10 and/or SINodeB 100, the direction finding equipment 240 performs 2G direction finding as described in further detail in WO2007/010220. That is, the direction finder 240 determines the direction of the device relative to the direction finder by measuring the direction of arrival of an uplink transmission signal which is transmitted by the MS/US 220 in one timeslot out of eight at the GSM frame rate. An alternative is to invoke a GSM GPRS Test Mode A or Test Mode B over the air in order to cause the MS/US 220 to start transmitting, and perform direction finding on this signal.

The protocol command sequence given above results in the MS/UE 220 being active on a GSM timeslot. Releasing the MS/UE 220 from this position is achieved by sending an RR Channel Release message from the SIMBTS 10 to MS/UE 220.

It is advantageous to augment the above process to retain the MS/UE 220 on GSM but not in a call. The importance of this technique is the forcing of the MS/UE 220 to stay on GSM. Conventionally the network on which a MS/UE will seek to go to is a complex combination of available networks' signal strength, SIM programming by the operators and MS/UE software/hardware capabilities. Most recent MS/UEs with conventional network operator SIM cards seek to go to a 3G network if one is available. There are logical commercial reasons for this a) a 3G network is more economical to operate and b) 3G typically has greater services which yield higher ARPU (average revenue per user). Therefore, for the operator of SINodeB and SIMBTS equipment, in areas of 3G coverage, an MS/UE will be typically found on 3G.

Controlling an MS/UE to be on 2G has the following benefits:
In areas where there is no 2G coverage, MS/UEs can be held isolated from either the 2G or 3G networks.
MS/UEs can be easier to control on 2G when no 3G network is available

The mechanism to create an MS/UE locked to 2G is as follows:
a) Configure the SIMBTS 10 such that no information is transmitted which allows the MS/UE 220, when camped on the SIMBTS 10, to derive a 3G neighbour list. This is usually included in System Information 2 Quater (SI2Q) or SI2ter messages (Note 3). This prevents the MS/UE from reselecting to 3G.
b) Configure the SINodeB 100 with a new control state which is “force from 3G to GSM and hold” which is applied selectively to target UEs with a preset IMSI and/or IMEI.
c) Implement the force from 3G to GSM process as described above in steps 1-21. At the end of step 21, the MS/UE 220 is engaged in a Blind call with the SIMBTS 10.
d) SIMBTS 10 then sends a Location Update Accept message to the MS/UE 220. This signals that the MS/UE 220 has successfully completed the location updating process (Note 4)
e) SIMBTS 10 then terminates the Blind call by sending a GSM RR Channel Release command to the MS/UE 220

Note 3: The SI2Quater message contains fields which define 3G neighbour cells including UARFCN and primary scrambling code. In addition they also contain measurement reporting instructions to instruct 3G UEs when to measure the particular neighbour cells.

Note 4: The Location Update Accept message is integrity protected when sent on 3G. Therefore the Location Update Accept from the SINodeB 100 would be rejected by MS/UE 220 due to incorrect Integrity parameters. The key difference is that there is no Integrity Protection when this message is sent on GSM. Hence the sequence of Location Update request from the UE sent on 3G can only be completed by sending a Location Update Accept on GSM from a SIMBTS.

Forcing an MS/UE from GSM to 3G is the reciprocal of the process of forcing from 3G to GSM described above. Details of the process are different and specialised. To enable the force from GSM to 3 G operation, an MS/UE capable of 3 G communications is camped on a normal GSM network. The MS/UE is then forced to 3G using an InterRAT handover from 2G to 3G. The MS/UE is then isolated on 3G and direction finding can be achieved using 3G techniques (as described in WO 2007/010220). This technique is useful for two purposes: a) only 3G direction finding equipment may be available due to operational or cost reasons; and b) direction finding using 3G techniques is more covert due to 3G signal energy being spread over a wider bandwidth.

The function to force MS/UE 220 from GSM to 3G function requires that the SINodeB 100 is working in cooperation with the SIMBTS 10. FIG. 5 illustrates that there is a link 230 over which cooperation messages are exchanged between the two units. The MS/UE 220 is handed from the SIMBTS 10 to the SINodeB 100 using a coordinated handover operation. The summary of the steps to Push a UE from 2G to 3G are as follows:
1 Configure the SIMBTS 10 with the IMSI and/or IMEI of one or more target MS/UEs with the control state “force from GSM to 3G”. This can be manually entered in by an operator with the information having been previously discovered. Alternatively the information can be acquired from devices using a method as described in WO 2007/010223; stored in an IMSI/IMEI database which is part of the SIMBTS 10 or at least available to it, and looked up from that database to configure the SIMBTS 10.
2 Configure SIMBTS 10 to a mode where 20 MSs in range will attempt to perform a Location Update process to the SIMBTS 10
3 SIMBTS 10 receives an RR Channel Request on the uplink RACH channel from MS/UE 220
4 SIMBTS 10 responds with an RR Immediate Assignment command sending MS/UE 220 to a specific GSM ARFCN and timeslot.
5 MS/UE 220 goes to the ARFCN and timeslot and establishes the RR connection with SIMBTS 10
6 MS/UE 220 sends an MM Location Update Request to the SIMBTS 10
7 SIMBTS 10 issues an MM Ciphering Mode Command to MS/UE 220
8 MS/UE 220 responds with MM Ciphering Mode Complete
9 SIMBTS 10 issues an MM Identity Request (IMSI), an MM Identity Request (IMEI) and optionally an MM Identity Request (TMSI)
10 MS/UE 220 responds with IMSI, IMEI and optionally TMSI identities.
11 SIMBTS 10 compares the IMSI and/or the IMEI identities with a target “force from GSM to 3G” list. If the identities match with one of the entries in the target list then the SIMBTS 10 begins the push from 2G to 3G process.
12 SIMBTS 10 issues a bespoke message over link 230 to the SINodeB 100 requesting 3G Handover channel parameters
13 SINodeB 100 responds to the SIMBTS 10 with the Handover Channel parameters on link 230
14 SINodeB 100 is configured to accept MS/UE 220 using the parameters sent to the SIMBTS 10 SIMBTS 10 issues a Handover to UTRAN Command to the MS/UE 220
16 MS/UE 220 receives the Handover to UTRAN command and immediately moves to the 3G bearer setup by SINodeB 100
17 SINodeB 100 and MS/UE 220 set up an RRC connection. The RRC connection is maintained using techniques described in detail in WO 2007/010220
18 SINodeB 100 sends a Handover Success message to the SIMBTS 10 over link 230
19 SIMBTS 10 then removes radio resources and contexts assigned to MS/UE 220

At the end of step 19, MS/UE 220 is set up in a Blind call on SINodeB 100. Direction finding on 3G can now take place as described in detail in WO 2007/010220. That is, the direction finder 240 determines the direction of an encoded 3G locator signal from the MS/US 220 by detecting the locator signal with an array of N antennas, separately decoding an output of each antenna to generate N decoded outputs, and measuring the direction of arrival of the locator signal by analyzing the N decoded outputs.

Although the invention has been described above with reference to one or more preferred embodiments, it will be appreciated that various changes or modifications may be made without departing from the scope of the invention as defined in the appended claims.

1. A method of forcing a mobile device to handover from a first cellular network radio access technology to a second radio access technology different from the first cellular network radio access technology, the method comprising:
a. establishing a connection with the mobile device using the first cellular network radio access technology;
b. sending a handover command to the device using the first cellular network radio access technology, the handover command including details of radio resources of the second cellular network radio access technology; and
c. establishing a connection with the mobile device using the radio resources of the second cellular network radio access technology which were specified in the handover command,
wherein steps a., b. and c. are each performed by a separately introduced base station which is not under the control of a cellular network.

2. The method of claim 1 wherein the first or second cellular network radio access technology is a frequency-division multiple-access technology.

3. The method of claim 1 wherein the first or second cellular network radio access technology is a code-division multiple-access technology.

4. The method of claim 1 wherein one of the cellular network radio access technologies is a frequency-division multiple-access technology, and the other is a code-division multiple-access technology.

5. The method of claim 1 wherein the handover command is sent to the device before the separately introduced base station is required to complete an authentication process with the device.

6. The method of claim 1 wherein the radio resources comprise information identifying a channel of the second cellular network radio access technology.

7. The method of claim 1 further comprising configuring the separately introduced base station which establishes a connection with the mobile device using the radio resources of the second cellular network radio access technology to hold the device and prevent it from performing a handover to the first cellular network radio access technology.

8. The method of claim 1 further comprising selecting a target device; and configuring the separately introduced base station to force the target device to handover by performing steps a., b. and c.

9. The method of claim 8 wherein the separately introduced base station is configured by entering into the separately introduced base station an identifier associated with the target device.

10. The method of claim 9 further comprising sending an identity request to the target device from the separately introduced base station, and receiving the identifier from the target device in response to the identity request.

11. The method of claim 1 wherein step a. comprises establishing an RRC or RR connection with the mobile device.

12. The method of claim 1 wherein the handover command is an “RRC Handover to UTRAN” command or an “RRC Handover from UTRAN” command.

13. A method of determining the direction of a mobile device, the method comprising forcing the device to handover to the second radio access technology by the method of claim 1; receiving a locator signal from the device at a direction finder using the second cellular network radio access technology; and determining the direction of the device relative to the direction finder by measuring the direction of arrival of the locator signal.

14. A computer program product which, when run on one or more computers, causes the computer(s) to perform a method according to claim 1.

15. Apparatus for forcing a mobile device to handover from a first cellular network radio access technology to a second radio access technology different from the first cellular network radio access technology, the apparatus comprising:
a. a first separately introduced base station configured to establish a connection with the mobile device using the first cellular network radio access technology, and send a handover command to the device using the first cellular network radio access technology, the handover command causing the device to handover to the second cellular network radio access technology;
b. a second separately introduced base station configured to establish a connection with the mobile device using the second cellular network radio access technology; and
c. a communication link between the first and second separately introduced base stations,
wherein the first and second separately introduced base stations are not under the control of a cellular network.
